(19) United States
(12) Patent Application Publication
(10) Pub. No.: US 2011/0012856 A1
(43) Pub. Date: Jan. 20, 2011

(54) Methods for Operation of a Touch Input Device

(75) Inventors: Ian Andrew Maxwell, New South Wales (AU); Dax Kukulj, Acton (AU); Brigg Maund, Acton (AU); Graham Roy Atkins, Acton (AU)

Correspondence Address: MILLER, MATTHIAS & HULL, ONE NORTH FRANKLIN STREET, SUITE 2350, CHICAGO, IL, 60606, US

(73) Assignee: RPO Pty. Limited, Acton, ACT (AU)

(21) Appl. No.: 12/921,202

(22) PCT Filed: Mar. 5, 2009
(86) PCT No.: PCT/AU2009/000274

§ 371 Date: Sep. 7, 2010

(30) Foreign Application Priority Data
Mar. 5, 2008 (AU) 2008901068
May 16, 2008 (AU) 2008902412

(51) Int. Cl. G06F 3/041

(52) U.S. Cl. 345/173

(57) ABSTRACT

The invention provides a method for operation of a touch input device comprising a touch input area. The method comprises the steps of (i) detecting a touch or near-touch of an object on or near said touch input area; (ii) determining a parameter indicative of the size and/or shape of said object; (iii) comparing said parameter with at least one predetermined value; and (iv) enabling an operational state of said touch input device in response to said comparison. The parameter may be compared with one or more threshold values which delimit the operational state of the input device. Such operational states include a sleep mode or active mode, the use of a full QWERTY or reduced keyboard, translation or rotation of graphical elements, etc. The method is particularly suitable for differentiating between a touch by a stylus or touch by a finger.

### FIELD OF THE INVENTION

The present invention relates to methods for operation of a touch input device and in particular to methods of operation where the operational state of the touch input device is contingent upon the type; size or shape of a detected touch object. The invention has been developed primarily for use with touch input devices that include a display capable of presenting a plurality of user-selectable graphical elements, and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Input devices based on touch sensing (touch screens) have long been used in electronic devices such as computers, personal digital assistants (PDAs), handheld games and point of sale kiosks, and are now appearing in other portable consumer electronics devices such as mobile phones. Generally, touch-enabled devices allow a user to interact with the device by touching one or more graphical elements, such as icons or keys of a virtual keyboard, presented on a display.

Several touch-sensing technologies are known, including resistive, capacitive, projected capacitive, surface acoustic wave and optical, all of which have advantages and disadvantages in areas such as cost, reliability, ease of viewing in bright light, ability to sense different types of touch object, e.g. finger, gloved finger, stylus, and single or multi-touch capability. For example resistive touch screens are inexpensive and can sense virtually any rigid touch object, but have poor screen viewability in bright light and can only sense single touches. Projected capacitive has multi-touch capability but cannot sense a non-conductive stylus or a gloved finger, and likewise has poor screen viewability in bright light. Optical has good screen viewability in bright light, limited multi-touch capability and is sensitive to virtually any touch object, but there is the potential for the detectors to be saturated by sunlight.

Furthermore some touch-sensing technologies, including optical and surface acoustic wave, are sensitive to near-touches as well as to actual touches, whereas other technologies such as resistive require an actual touch.

The sensitivity of some touch technologies to selected types of touch object can be used to advantage. For example U.S. Pat. Nos. 4,686,332 and 5,956,020 describe capacitive touch screens that, in addition to detecting finger touch, can detect an active stylus from signals emitted by the stylus, while U.S. Pat. No. 5,777,607 and US Patent Publication No 2001/0013855 A1 describe touch tablets that detect finger touch capacitively and stylus touch resistively. This finger/stylus discrimination enables the touch system controller to reject an inadvertent ‘palm touch’ from a user's hand holding the stylus, or to make decisions as to which applications or operations to enable.

Several touch technologies are able to distinguish different types of touch object based on the size of the object, with size determined either as a linear dimension (e.g. using resistive touch in Japanese Patent Publication No 2004213312 A2 or infrared touch in U.S. Pat. No. 4,672,195 and U.S. Pat. No. 4,868,912) or a contact area (e.g. using projected capacitive touch in US 2006/0026535 A1 or in-cell optical touch in U.S. Pat. No. 7,166,966). In some cases (U.S. Pat. No. 4,672,195, U.S. Pat. No. 4,868,912) size information is used to reject touch objects that are too small (e.g. an insect) or too large (e.g. a ‘palm touch’), while in other cases (US 2006/0139340 A1) it can help resolve ‘phantom’ touches from real touches in the ‘double touch ambiguity’ that occurs with some touch technologies, or to decide whether to activate an icon being touched (US 2006/0053387 A1). In yet other cases, described fox example in U.S. Pat. No. 7,190,348, US 2008/0204421 A1 and US 2008/0284751 A1, size information is used to distinguish between stylus and finger touch. It has also been suggested that stylus and finger touch can be distinguished on the basis of pressure (JP 04199416 A2), temperature or direct imaging (US 2008/0284751 A1).

Irrespective of the means used to distinguish between finger and stylus touch, several groups have used the information to address the problem of using a finger (a convenient but relatively large touch object) to select small icons accurately. Known methods for improving finger operation of a touch screen include presenting a set of larger icons (U.S. Pat. No. 7,190,348, JP 2003271310 A2, US 2005/0237310 A1, US 2007/0057926 A1, US 2008/0284743 A1), enlarging a portion of the touch interface (US 2006/0026535 A1), and using an offset cursor (U.S. Pat. No. 7,190,348, US 2008/0204421 A1).

The concept of gestural inputs, where a user moves one or more touch objects (usually fingers, with the thumb considered to be a finger) across a touch-sensitive surface, or places one or more touch objects on a touch-sensitive surface in a particular sequence, are an increasingly popular means for enhancing the power of touch input devices beyond the simple ‘touch to select’ function, with a large number of gestures of varying complexity for touch input devices known in the art (see for example US Patent Publication Nos 2006/0026535 A1, 2006/0274046 A1 and 2007/0177804 A1). A given gesture may be interpreted differently depending on whether the touch object is a finger or stylus. In one example (U.S. Pat. No. 6,611,258) a drawing application may interpret a stroke as a line when performed by a stylus or as an erase gesture when performed by a finger. In another (US 2008/0284743 A1) a stylus or finger stroke may be interpreted as a ‘panning’ gesture or an erase gesture. As discussed in US 2006/0097991 A1, touch technologies such as projected capacitive that can accurately detect several simultaneous touch events are particularly well suited to gestural input, with gestures interpreted according to the number of fingers used. US 2007/0177804 A1 discusses the concept of a ‘chord’ as a set of fingers contacting a multi-touch surface, and suggests the use of a gesture dictionary assigning gestures to different motions of a chord. However for touch technologies with no multi-touch capability (e.g. resistive and surface capacitive) or limited multi-touch capability (e.g. infrared and surface acoustic wave), gestural input based on chords is of limited applicability.

### OBJECT OF THE INVENTION

It is an object of the present invention to overcome or ameliorate at least one of the disadvantages of the prior art, or to provide a useful alternative.

It is an object of the invention in its preferred form to provide a method for operation of a touch input device where the operational state of the device is contingent on the type, size or shape of the object used to provide the touch input.

### SUMMARY OF THE INVENTION

In a first aspect, the present invention provides a method for operation of a touch input device comprising a touch input area, said method comprising the steps of (i) detecting a touch or near-touch of an object on or near said touch input area; (ii) determining a parameter indicative of the size and/or shape of said object; (iii) comparing said parameter with at least one predetermined value; and (iv) enabling an operational state of said touch input device in response to said comparison, wherein said operational state is a sleep mode or an active mode.

In a preferred form of the invention the predetermined values are threshold values and the parameter is compared with said threshold values to determine which function is enabled by the touch object. The predetermined value may be compared with a single threshold value such that if the parameter is greater than the threshold value the device enters a sleep mode, and if the parameter is less than or equal to the threshold value it enters an active mode. In an alternative embodiment, the predetermined values are a set of threshold values whereby the parameter is compared with a first lower threshold value and a second upper threshold value greater than the first lower threshold value. If the parameter is greater than the second threshold value the device enters sleep mode, and if the parameter is less than the first threshold value the device enters an active mode.

In a second aspect, the present invention provides a method for operation of a text entry mode of a touch input device comprising a touch input area operatively associated with a display; said method comprising the steps of: (i) detecting a touch or near-touch of an object on or near said touch input area (II) determining whether said touch object is a stylus or a finger; and (iii) displaying on said display a full keyboard if said touch object is determined to be a stylus, or a reduced keyboard if said touch object is determined to be a finger.

In a third aspect, the present invention provides a method for operation of a touch input device comprising a touch input area operatively associated with a display, said method comprising the steps a (i) detecting a touch or near-touch of an object on or near said touch input area; (ii) determining the size and/or shape of said object; and (iii) displaying a cursor on said display in response to said determining step, wherein said cursor is a graphical representation of the determined touch object.

In a fourth aspect, the present invention provides a method for operation of a touch input device comprising a touch input area operatively associated with a display, said method comprising the steps of: (i) detecting a touch or near-touch of an object on or near said touch input area; (ii) determining whether said touch object is a stylus or a finger; and (iii) displaying a cursor on said display in response to said determining step, wherein said cursor is a graphical representation of the determined touch object.

According to this aspect, in a preferred form the cursor may be a graphical representation of a stylus or a handholding stylus if said touch object is determined to be a stylus. Alternatively the cursor may be a graphical representation of a pointing hand, a finger or a group of fingers if said touch object is determined to be a finger or group of fingers.

In a fifth aspect, the present invention provides a method for operation of a touch input device comprising a touch input area, said method comprising the steps of: (i) detecting a touch or near-touch of an object on or near said touch input area; (ii) determining a parameter indicative of the size and/or shape of said object; and (iii) presenting said parameter to a user of said device.

According to this aspect, the parameter may be displayed on a display operatively associated with said touch input area. The parameter may be displayed graphically and/or alphanumerically in one or more dimensions to the user of the device.

In a sixth aspect, the present invention provides a method for operation of a touch input device comprising a touch input area, said method comprising the steps of i) detecting a touch or near-touch of an object on or near said touch input area, said object comprising one or more fingers bunched together: ii) determining a parameter indicative of the size and/or shape of said object; comparing said parameter with at least one predetermined value and (iv) on the basis of said comparison, differentiating said object as a single finger or as a plurality of fingers bunched together.

Preferably, the parameter is compared with one or more predetermined threshold values, these threshold values delimiting a plurality of functions such that the size and/or shape of said object enables one or more of said functions.

In a seventh aspect, the present invention provides a method for interacting with a touch input device comprising a touch input area, said method comprising placing one more touch objects on or near said touch input area wherein at least one of said touch objects comprises at least two fingers bunched together.

In preferred forms of the invention the number and magnitude of the predetermined values may be user definable. In some embodiments the parameter would include at least one linear dimension of said object with for example, a linear dimension threshold value in the range of 2 mm to 5 mm.

In other embodiments the predetermined value may include an area of said object with, for example, an area threshold value in the range of 4 mm² to 25 mm².

In a still further embodiment the parameter may include a measure of symmetry of the object.

The display which is operatively associated with the touch input area is preferably but not necessarily coincident with said touch input unit.

### BRIEF DESCRIPTION OF THE DRAWINGS

Preferred embodiments of the invention will now be described, by way of example only, with reference to the accompanying drawings in which:

FIG. 1 illustrates a plan view of an infrared touch input device;

FIG. 2 illustrates a plan view of the infrared touch input device of FIG. 1 showing the dimensioning of touch objects;

FIG. 3 illustrates a plan view of another infrared touch input device;

FIG. 4 illustrates a plan view of a touch input device displaying a QWERTY keyboard for text entry;

FIG. 5 illustrates a plan view of a touch input device displaying a reduced keyboard for text entry;

FIG. 6 illustrates a plan view of a touch input device displaying a set of tabs for selection of an operational or data entry mode;

FIG. 7 illustrates the presentation to a user of the linear dimensions of a touch object;

FIGS. 8A to 8D illustrate how analysis of a parameter indicative of the size of a touch object can be used to determine the effect of a gesture;

FIG. 9 illustrates a conventional rotation gesture using two separated fingers;

FIG. 10 illustrates how the conventional rotation gesture of FIG. 9 can be misinterpreted by a touch input device having limited multi-function capability; and

FIG. 11 illustrates how a double touch ambiguity can be avoided for two different-sized touch objects.

### PREFERRED EMBODIMENTS OF THE INVENTION

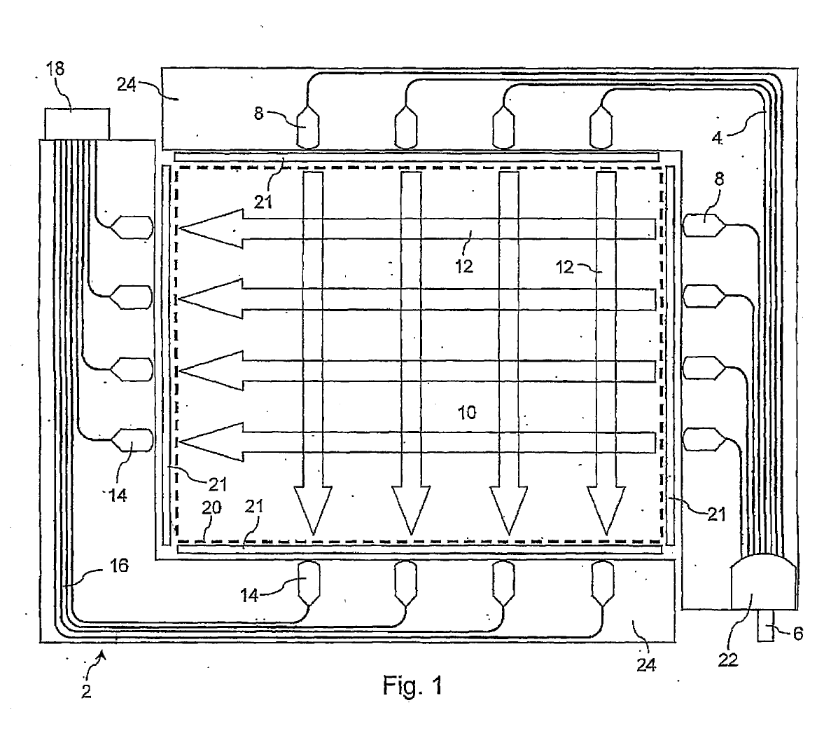

Referring to the drawings, FIG. 1 shows a touch input device 2 that uses a grid of light beams to detect a touch. Infrared light is typically used, but visible or ultraviolet light could also be used. In this style of touch input device, disclosed in U.S. Pat. No. 5,914,709 for example, integrated optical waveguides (‘transmit’ waveguides) 4 conduct light from a single optical source 6 to integrated in-plane lenses 8 that collimate the light in the plane of an input area 10 and launch a grid of light beams 12 across the input area. The light is collected by a second set of integrated in-plane lenses 14 and integrated optical waveguides (‘receive’ waveguides) 16 at the other side of the input area, and conducted to a position-sensitive (i.e. multi-element) detector 18. A touch object (e.g. a finger or stylus) cuts one or more of the beams of light and is detected as a shadow, with its position determined from the particular beam(s) blocked by the object. That is, the position of any physical blockage can be identified in each dimension, enabling user feedback to be entered into the device. Typically, the grid of light beams 12 is established in front of a display 20 such as an LCD, so that a user can select or interact with graphical elements presented on the display. In preferred embodiments the input area 10 is essentially coincident with an underlying display 20, but in other embodiments there may be no display at all or, as disclosed for example in Australian Patent Application No 2008202049 entitled ‘Input device’ and incorporated herein by reference, the display occupies only a portion of the input area. Preferably, the device also includes external vertical collimating lenses (VCLs) 21 adjacent to the integrated in-plane lenses 8 and 14 on both sides of the input area 10, to collimate the light beams 12 in the direction perpendicular to the plane of the input area.

As shown in FIG. 1, the touch input devices are usually two-dimensional and rectangular, with two arrays (X, Y) of ‘transmit’ waveguides along two adjacent sides of the input area, and two corresponding arrays of ‘receive’ waveguides along the other two sides. As part of the transmit side, in one embodiment light from a single optical source 6 (such as an LED or a vertical cavity surface emitting laser (VCSEL)) is distributed to a plurality of transmit waveguides 4 forming the X and Y transmit arrays via some form of optical splitter 22, for example a 1×N tree splitter. The X and Y transmit waveguides are usually fabricated on an L-shaped substrate 24, and likewise for the X and Y receive waveguides, so that a single source and a single position-sensitive detector can be used to cover both X and Y axes. However in alternative embodiments, a separate source and/or detector may be used for each of the X and Y axes. It will be appreciated that because the beams 12 are established in front of the display 20, the touch input device 2 will be sensitive to a near-touch as well as to an actual touch on the display or input area.

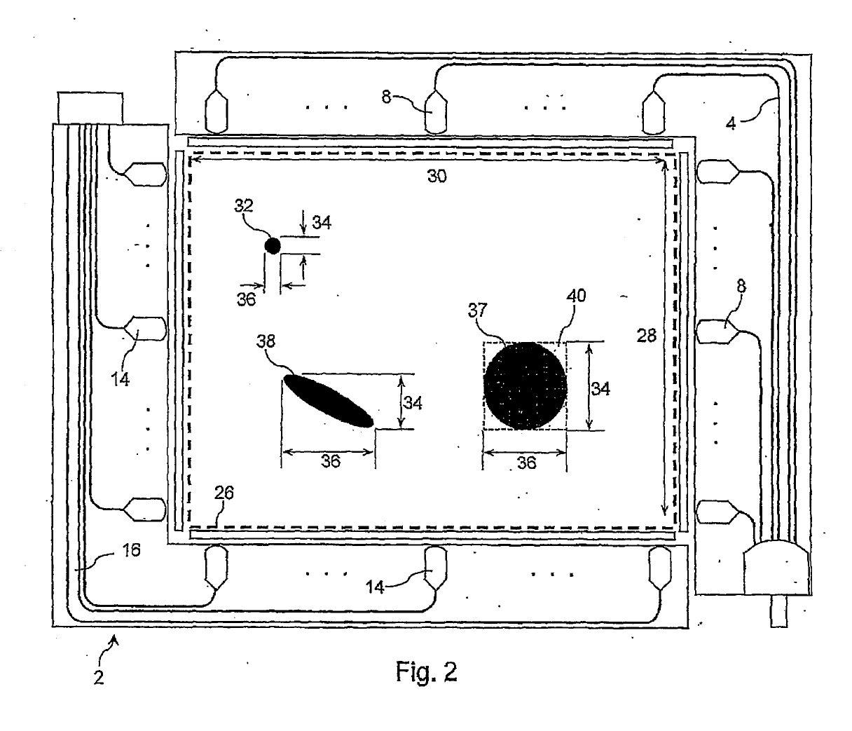

For simplicity, FIG. 1 only shows four waveguides per side of the input area 10; in actual touch input devices there will generally be sufficient waveguides for substantial coverage of the input area. For reliable detection of touch input, it is also necessary for the input device to have sufficient resolution to detect the smallest likely touch object. In one specific embodiment shown in FIG. 2, a touch input device 2 is integrated with a 3.5″ (89 min) display 26 with short site dimension 28 equal to 53 mm and long side dimension 30 equal to 70 mm. This touch input device has 49 transmit waveguides 4 and 49 receive waveguides 16 (and their respective integrated in-plane lenses 8, 14) on a limn pitch along each short side and 65 waveguides on a 1 mm pitch along each long side. This ensures that a stylus 32 with tip diameter 1 mm will block a substantial portion of at least one beam in each axis, and will therefore be detectable. A finger 37 with diameter 10 mm will block ten beams in each axis, and will clearly be distinguishable from a stylus 32. The number of beams blocked or substantially blocked by a touch object is used to determine a dimension of the object, by any one of a number of algorithms known in the art, including for example grey scale algorithms. By way of simple example, a stylus 32 blocking a substantial portion of one beam in each axis will be assigned linear dimensions 34, 36 of 1 mm per axis, while a finger 37 blocking ten beams in each axis will be assigned linear dimensions 34, 36 of 10 mm per axis. In the case of an elongated touch object 38, such as the corner of a credit card, the number of beams blocked in each axis will depend on the object's orientation vis-à-vis the beam axes, but it will still be possible to assign linear dimensions 34, 36 for each axis.

Another size-related measure that can be calculated is an interaction area 40 between a touch object and a display. For the optical touch input device 2 shown in FIG. 2, the interaction area 40 is determined from the product of the linear dimensions 34 and 36. As mentioned above, touch technologies such as projected capacitive and in-cell optical, with arrays of sensing nodes across the input area, enable an interaction area to be inferred directly from the number of nodes contacted by the touch object. Within the limitations of the node spacing, an interaction area measured in this manner will often be a more accurate reproduction of the actual contact area between a touch object and the input surface than the ‘rectangular’ interaction area 40 shown in FIG. 2.

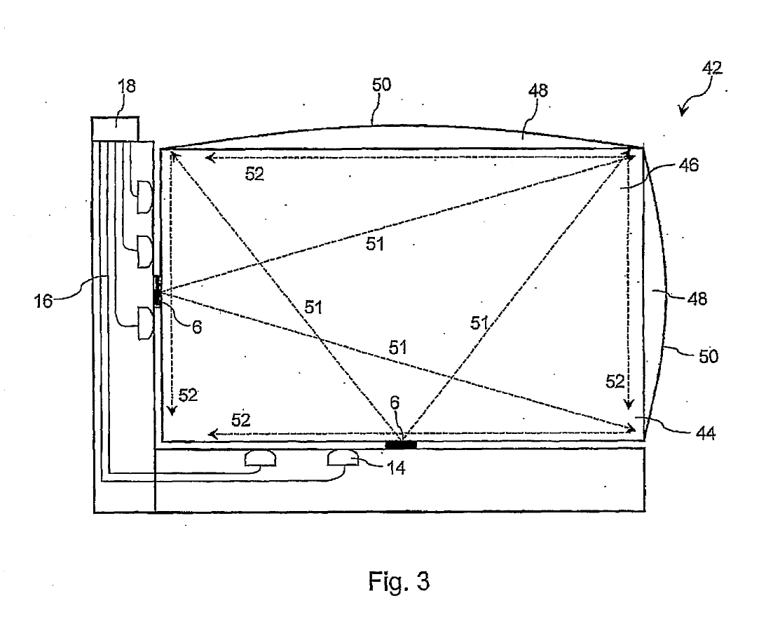

In an alternative form of input device 42 shown in FIG. 3, disclosed in US 2008/0278460 A1 entitled ‘Transmissive body’ and incorporated herein by reference, the transmit waveguides and in-plane lenses are replaced by a transmissive body 44 including a planar transmissive element 46 and two collimation/redirection elements 48 that include parabolic reflectors 50. Light 51 from a pair of optical sources 6 is launched into the transmissive element 46, then collimated and re-directed by the elements 48 to produce two laminae of light 52 that propagate in front of the transmissive element 46 towards the receive waveguides 16. Similar to the situation with the ‘all waveguide’ input device 2, a touch or near-touch event is detected and its dimensions determined from those portions of the laminae 52 blocked by a touch object, and the spatial resolution is determined by the number and spacing of the receive waveguides. Clearly the transmissive element 46 needs to be transparent to the light 51 emitted by the optical sources 6, and it also needs to be transparent to visible light if there is an underlying display (not shown). Alternatively, a display may be located between the transmissive element 46 and the laminae 52, in which case the transmissive element need not be transparent to visible light.

In a first aspect of the present invention, the size and/or shape of a detected touch object are used to determine whether an input device should be in sleep mode or active mode. For example when an optical touch input device 2 or 42 is in sleep mode, it operates at a frame rate of order one frame per second (with a ‘frame’ including pulsing the optical source(s) 6 and scanning the multi-element detector 18), whereas in active mode it operates at much higher frame rates, of order 100 frames per second or even higher for demanding applications such as signature capture. In general an input device will remain is sleep mode whenever possible, to conserve power. For example if an input device in active mode is placed into a pocket or a sleeve, the device controller will detect the pocket or sleeve as a touch with a parameter indicative of size and/or shape larger than a predetermined value and will direct the device to enter sleep mode. In certain embodiments the device will only enter sleep mode if this ‘large’ touch persists for a certain time. Optionally the device may provide a warning message such as a beep before entering sleep mode, which could be useful if a user were inadvertently resting their band on the input area. Alternatively or additionally, if the input device is in sleep mode and detects a touch object with a parameter indicative of size and/or shape smaller than a predetermined value, e.g. consistent with a stylus or finger, the controller will direct the input device to enter active mode. We note that this aspect does not require the presence of a display, i.e. it is applicable to touch panel devices where the input area does not coincide with a display.

In another embodiment the predetermined values may be two predetermined threshold values with which the size and/or shape indicative parameter is compared, with a first predetermined threshold value being smaller than a second predetermined threshold value. A device in sleep mode will enter active mode if it detects a touch object with size and/or shape parameter smaller than the first predetermined threshold value, and a device in active mode will enter sleep mode if it detects a touch object with size and/or shape parameter larger than the second predetermined threshold value. By setting the second predetermined threshold value to correspond to a significant fraction of the input area, i.e. much larger than a finger, the likelihood of a user inadvertently sending the device into sleep mode, say with a palm touch, is reduced.

In another aspect of the present invention, a touch input device controller first determines whether a touch object is a stylus or a finger, and then presents a suitable user interface for alphanumeric text entry. In preferred embodiments the stylus/finger decision is made based on determining a parameter indicative of the size and/or shape of the touch object as described below, but in alternative embodiments the decision is made based on one or more other criteria known in the art, including those described previously. If the device controller determines that the touch object is a stylus, it presents a full keyboard (such as a QWERTY keyboard or the like, including variations used for alphabet-based languages other than English), or a reduced keyboard (such as a T9 keypad), with multiple characters per key, if the touch object is a finger. Many other types of reduced keyboards are known in the art, including an expanding circular arrangement disclosed in US 2007/0256029 A1 entitled ‘Systems and methods for interfacing a user with a touch screen’ and incorporated herein by reference. A QWERTY keyboard has the advantage of unambiguous input but requires a larger display area, whereas reduced keyboards require a smaller display area but frequently need some form of ‘disambiguation’ routine and are often slower to use. We note that U.S. Pat. No. 6,611,258 discloses a somewhat contrary text entry system where a QWERTY keyboard is presented for finger touch, and a character drawing pad for stylus touch.

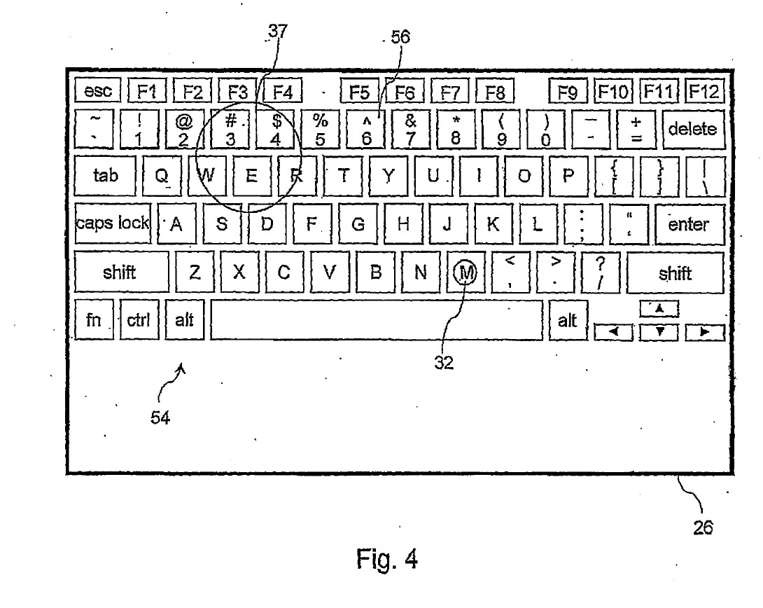

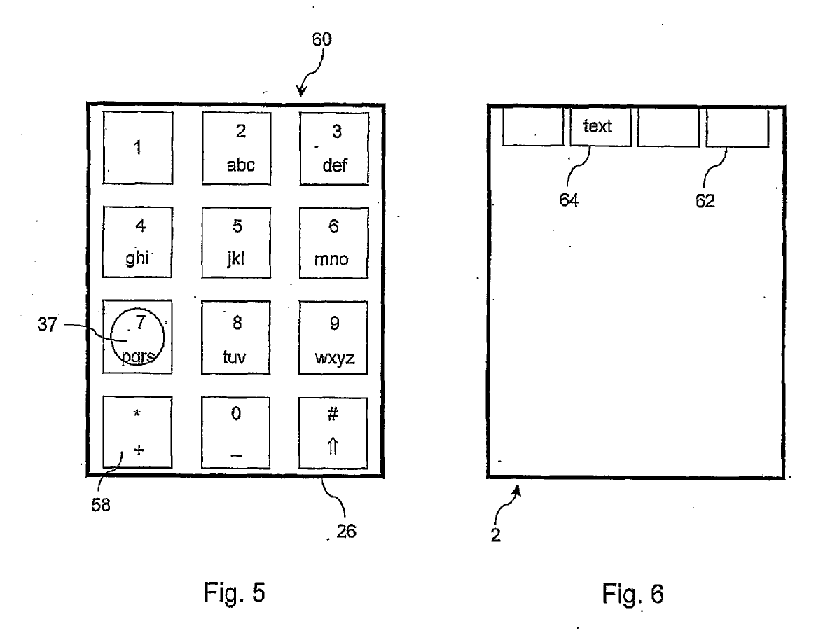

By way of specific example, FIG. 4 shows a QWERTY keyboard 54 displayed on the 53 mm×70 mm display 26 of FIG. 2, with a plurality of graphical elements in the form of virtual keys 56 of order 5 mm×5 mm in size. Virtual keys of this size would be difficult to select reliably with a finger 37, meaning that with this size display, a QWERTY keyboard is an inappropriate means for text entry via finger touch. In contrast, the virtual keys 56 could easily be reliably selected with a stylus 32. As shown in FIG. 5, the twelve keys 58 of a standard T9 reduced keyboard 60, of a size suitable fox selection by finger touch 37, are easily accommodated on a 53 mm×70 mm display 26.

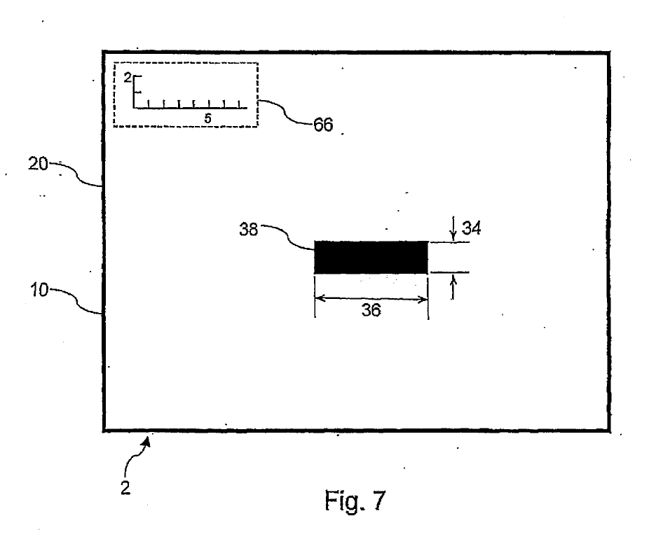

In a preferred embodiment shown in FIG. 6, a touch input device 2 awaiting input displays a set of graphical elements in the form of tabs 62 enabling a user to select an operational or data entry mode, including a ‘text entry’ tab 64. When the user touches the ‘text entry’ tab, the device controller determines the parameter indicative of the size and/or shape of the touch object, compares them with one or more predetermined values; and based on this comparison decides to display either a QWERTY keyboard 54 or a reduced keyboard 60. In one embodiment the controller determines one or more linear dimensions 34 and 36, and the comparison is made between these linear dimensions and one or two predetermined thresholds. For example a linear threshold in the range of 2 mm to 5 mm would be suitable for distinguishing a finger touch 37 from a stylus touch 32, such that a QWERTY keyboard is displayed if the linear dimensions are both less than the linear threshold, and a reduced keyboard is displayed if at least one of the linear dimensions is greater than the linear threshold. In another embodiment the controller determines an interaction area 40, and the comparison is made between this area and a predetermined area threshold. For example an area threshold in the range of 4 mm² to 25 mm² would be suitable for distinguishing a finger touch 37 from a stylus touch 32. Similarly, a QWERTY keyboard or a reduced keyboard is displayed if the interaction area is less than or greater than the area threshold respectively.

In another aspect of the present invention the parameter determined by the controller to identify the touch object is a parameter indicative of shape. The determination of this parameter may be quite straightforward such as measuring a plurality of linear dimensions to determine the actual shape, or give a measure of the symmetry of the object producing the touch or near touch.

In certain embodiments the number or magnitudes of the one or more predetermined threshold values are fixed, while in other embodiments they are user-definable. In alternative embodiments, a decision as to which keyboard to display is made based on a touch made anywhere on the display. In yet other embodiments, the displayed keyboard can be changed dynamically during text entry, say if the user switches between finger and stylus operation.

In another aspect of the present invention, a touch input device controller first determines the origin of the touch or near touch eg. whether a touch object is a stylus, a finger or bunch of fingers in contact with each other, or another object such as a credit card. The device then presents a cursor with shape indicative, of the touch object, for example a pointing hand or a finger for finger touch, or a stylus or a band holding a stylus for a stylus. In general the intuitive part of the cursor (i.e. the fingertip or stylus tip) will be the ‘hot spot’ of the cursor, and the cursor may be coincident with the touch object or offset as is known in the art. In preferred embodiments the stylus/finger decision is made based on measuring one or more dimensions of the touch object as described below, but in alternative embodiments the decision is made based on one or more other criteria known in the art including those described previously.

By way of specific example, if a touch input device controller detects a touch object with both linear dimensions less than a predetermined linear threshold of 5 mm it will display a cursor shaped like a stylus or pen, and if it detects a touch object with both linear dimensions greater than the predetermined linear threshold it will display a cursor shaped like a finger. In another example, a touch input device controller will display a cursor shaped like a stylus or pen if it detects a touch object with interaction area less than a predetermined area threshold of 25 mm², or a cursor shaped like a finger if it detects a touch object with interaction area greater than the predetermined area threshold.

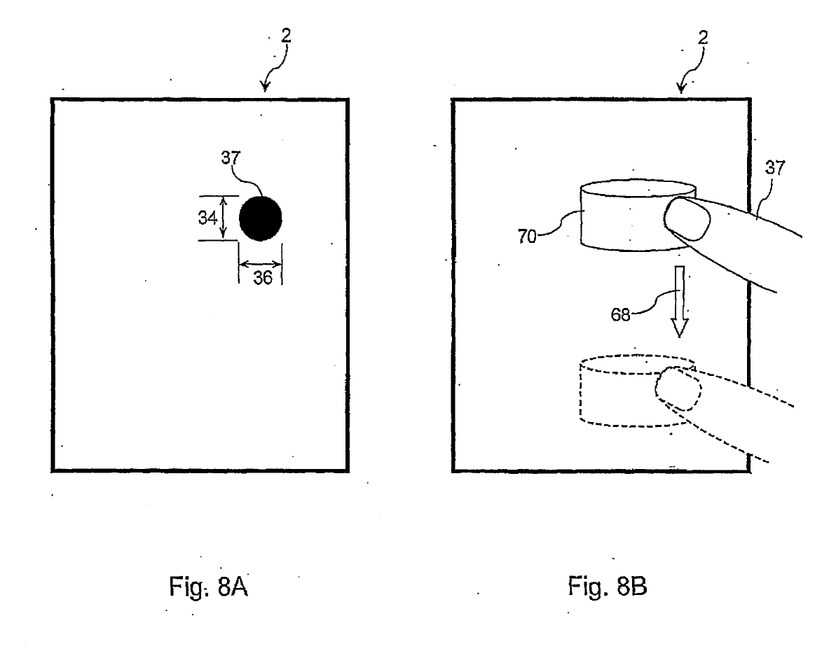

In a fourth aspect of the present invention, a touch input device has a ‘measure object’ mode (enabled for example by tab 65 in FIG. 6) whereby the device controller determines one or more parameters indicative of the size and/or shape of a touch object and presents that information to a user. In one example illustrated in FIG. 7, the controller of a touch input device 2 determines the linear dimensions 34, 36 of a touch object 38 and presents those dimensions in the form of a ruler-like graphical element 66 on a display 20 with units (e.g. mm or inches) that may be pre-set or user-determined. Alternatively the dimensions could be presented in some other form, such as text. This ‘measure object’ mode feature enables a user to measure the linear dimensions of an object, subject to the limitation of the spatial resolution of the input device, which may be useful in the absence of a ruler for example. In another example, the controller determines an interaction area of a touch object and presents that information to a user. For input devices with an array of sensing nodes capable of determining a measure of the actual contact area between a touch object and the input surface, this feature enables a user to determine shape eg. symmetry of an object, and/or measure an area of an object that may otherwise be difficult to determine (e.g. the area of an irregularly shaped surface). In yet another example, a ‘measure object’ mode may measure the separations between multiple touch objects and present this information to a user.

In the example illustrated in FIG. 7, the size and/or shape indicative parameter may be presented on a display 20 substantially coincident with the touch input area 10. In other embodiments the touch input area does not coincide with a display, and the parameter e.g. dimensions, area, shape etc are presented graphically on a separate display, or aurally.

A further aspect of the present invention concerns gestural input for touch technologies with limited or no multi-touch capability. For example a resistive touch screen is limited to a single touch point, with two simultaneous touch events being reported as a single touch event midway between the two touch objects. As explained in PCT Patent Publication No WO 2008/138046 A1 entitled ‘Double touch inputs’ and incorporated herein by reference, touch technologies relying on two intersecting energy paths to determine the location of a touch object, such as the ‘infrared’ technologies illustrated in FIGS. 1 to 3, have some multi-touch capability but suffer from an ambiguity when confronted with two simultaneous touch events.

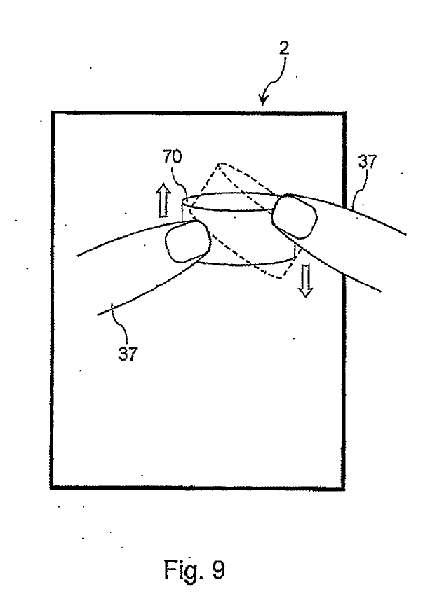

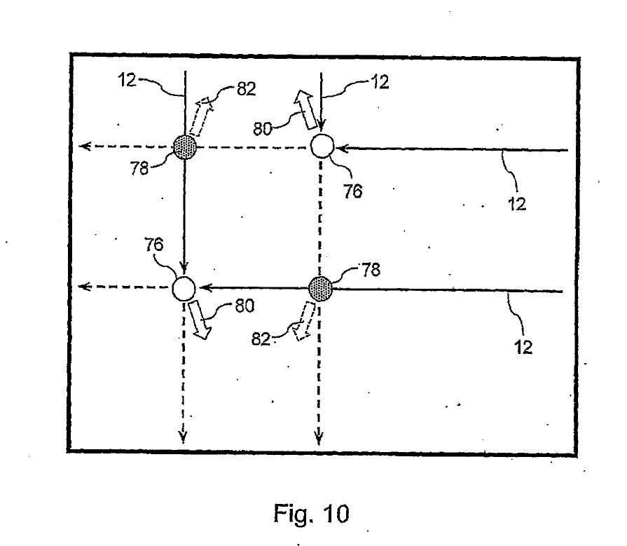

This ‘double touch ambiguity’ can lead to certain gestures being misinterpreted. For example FIG. 9 shows a rotation gesture (discussed in US 2006/0026535 A1) suitable for a multi-touch capable device where a graphical element 70 is rotated by two separated fingers 37 moving clockwise or anticlockwise. As shown in FIG. 10 however, the inability of intersecting light beams 12 to distinguish reliably between a pair of real touch points 76 and a pair of ‘phantom’ touch points 78 causes a problem in that an anticlockwise movement 80 of a pair of real touch points may be indistinguishable from a clockwise movement 82 of the corresponding pair of ‘phantom’ touch points, so that a device controller could rotate a graphical element the wrong way.

The present invention provides a device controller that uses touch object recognition to determine whether a given gesture includes two or more adjacent or bunched fingers, and assigns a function accordingly. Unlike the ‘chords’ of the prior art where a user's fingers axe separated and individually detectable, bunched fingers place no multi-touch requirement on the device controller, since they are detected as a single touch event. On the basis of the determined parameter indicative of size and/or shape however, the number of fingers in a bunch can be determined, expanding the range of functions that can be applied to simple gestures such as a linear or arcuate swipe.

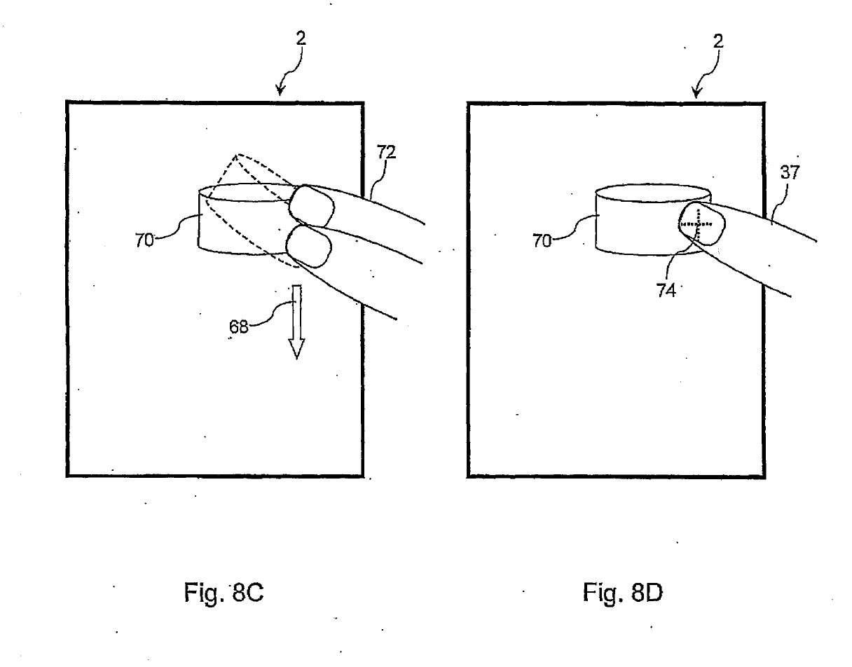

In a specific example of touch object dimensions being used to determine the effect of a gesture, FIGS. 8A to 8D show two different effects of a swipe gesture, depending on whether the gesture is performed with one finger or two bunched fingers. FIG. 8A shows a touch 37 of a finger on a touch input device 2, with the linear dimensions 34, 36 of the finger determined by the device controller. If both linear dimensions are less than a predetermined threshold of say 15 mm, the device controller will recognise the touch object as a single finger and, as shown in FIG. 8B, interpret movement 68 of the finger 37 as the known ‘pan’ or ‘translate’ gesture, and respond by translating a graphical element 70 being touched. Preferably, the threshold is user-definable to allow for different finger sizes, e.g. adult versus child. In another embodiment more than one linear dimension may be determined to ascertain whether the touch is substantially symmetrical or elongated. Generally a touch from a single finger will be substantially symmetrical. Touches from two or more bunched fingers will be elongated and non symmetrical. By measuring linear dimensions in the two axis of the display the controller can determine whether the touch is substantially symmetrical or elongated. This will in turn allow the controller to differentiate between a single touch and a touch by bunched fingers.

As shown in FIG. 5C on the other hand, if two bunched fingers 72 contact the input device 2, at least one of the linear dimensions will be greater than the 15 mm linear threshold. Accordingly, the device controller will recognise the touch object as two bunched fingers, and apply a ‘rotate’ function to the movement 68 whereby a graphical element 70 being touched is rotated, not translated. In one embodiment the graphical element will be rotated about its centre of gravity, which can be thought of as the default centre of rotation. In another embodiment, shown in FIG. 8D, a centre of rotation 74 can be specified by touching the graphical element 70 with a single finger 37 prior to performing the ‘bunched fingers’ rotate gesture. In this case, because the graphical element has already been selected, the graphical element need not actually be touched by the bunched fingers for it to be rotated. If more predetermined thresholds are defined, it will be possible to assign additional functions to gestures performed with other ‘bunching’ combinations, such as four fingers or two fingers and a thumb.

The ‘bunched fingers’ rotation shown in FIG. 8C is ‘freeform’ in that the graphical element is rotated smoothly with movement of the fingers over the display. In an alternative embodiment, the rotation is restricted to fixed increments, for example 15, 30 or 90 degrees. It will be appreciated that there are many means by which a user can inform the device controller of the desired form of rotation. In one example, the freeform rotation is the default form, while the fixed increment rotation is requested by tapping the display with the bunched fingers before commencing the rotation movement.

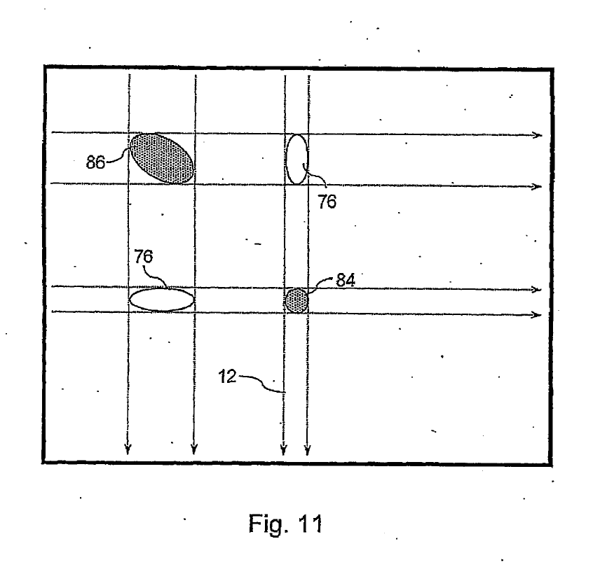

The concept of performing gestures with bunched fingers can be extended to chords that include both bunched and separate fingers, e.g. bunched index finger and middle finger with a separate thumb. In a touch system with multi-touch capability and the ability to determine touch object dimensions, this has the advantage of further increasing the ‘vocabulary’ of gestural input. Another advantage of such chords, particularly for touch technologies that are subject to double touch ambiguity, is that the two components of the chord will have quite different sizes. As recognised in US 2006/0139340 A1, a size differential is one means by which an ambiguity may be resolved. To explain further, FIG. 11 shows a thumb 84 and an index finger/middle finger bunch 86 as they might be detected by the beams 12 of an infrared touch screen. It will be appreciated that the two ‘phantom’ touch points 76 will appear to be different in shape from either of the real touch points, improving the likelihood of the device controller correctly identifying the real touch points.

Although the invention has been described with reference to specific examples, it will be appreciated by those skilled in the art that the invention may be embodied in many other forms.

1. A method for operation of a touch input device comprising a touch input area, said method comprising the steps of: (i) detecting a touch or near-touch of an object on or near said touch input area; (ii) determining a parameter indicative of the size and/or shape of said object; (iii) comparing said parameter with at least one predetermined value; and (iv) enabling an operational state of said touch input device in response to said comparison, wherein said operational state is a sleep mode or an active mode.

2. A method according to claim 1, wherein said predetermined value is a threshold value and said parameter is compared with a single threshold value, such that said device enters sleep mode if said parameter is greater than said threshold value, or enters active mode if said parameter is less than or equal to said threshold value.

3. A method according to claim 1, wherein said at least one predetermined value is a set of threshold values whereby said parameter is compared with a first lower threshold value and a second upper threshold value greater than said first lower threshold value, such that said device enters sleep mode if said parameter is greater than said second upper threshold value, or enters active mode if said parameter is less than said first lower threshold value.

4. A method for operation of a text entry mode of a touch input device comprising a touch input area operatively associated with a display, said method comprising the steps of: (i) detecting a touch or near-touch of an object on or near said touch input are; (ii) determining whether said touch object is a stylus or a finger; and (iii) displaying on said display a full keyboard if said touch object is determined to be a stylus, or a reduced keyboard if said touch object is determined to be a finger.

5. A method according to claim 4, wherein said determining step comprises the steps of: determining a parameter indicative of the size and/or shape of said object; and comparing said parameter with at least one predetermined value.

6. A method according to claim 4, wherein said full keyboard is a QWERTY keyboard or the like.

7. A method for operation of a touch input device comprising a touch input area operatively associated with a display, said method comprising the steps of: (i) detecting a touch or near-touch of an object on or near said touch input area; (ii) determining a parameter indicative of the size and/or shape of said object; (iii) performing a comparison between said parameter and at least one predetermined valve; (iv) classifying said touch object on the basis of said comparison; and (v) displaying a cursor on said display, wherein said cursor is a graphical representation of the classified touch object.

8. A method for operation of a touch input device comprising a touch input area operatively associated with a display, said method comprising the steps of (i) detecting a touch or near-touch of an object on or near said touch input area; (ii) determining whether said touch object is a stylus or a finger; and (iii) displaying a cursor on said display in response to said determining step, wherein said cursor is a graphical representation of the determined touch object.

9. A method according to claim 8, wherein said cursor is a graphical representation of a stylus or a hand holding a stylus if said touch object is determined to be a stylus.

10. A method according to claim 8, wherein said cursor is a graphical representation of a pointing hand, a finger or a group of fingers if said touch object is determined to be a finger or a group of fingers.

11. A method according to claim 8, wherein said determining step comprises the steps of: determining a parameter indicative of the size and/or shape of said object; and comparing said parameter with at least one predetermined value.

12. A method for operation of a touch input device comprising a touch input area, said method comprising the steps of: (i) detecting a touch or near-touch of an object on or near said touch input area; (ii) determining a parameter indicative of the size and/or shape of said object; and (iii) presenting said parameter to a user of said device.

13. A method according to claim 12, wherein said device further includes a display operatively associated with said touch input area, and said parameter is displayed on said display.

14. A method according to claim 13, wherein said parameter is displayed graphically or alphanumerically in one or more dimensions to a user of said device.

15. A method for operation of a touch input device comprising a touch input area, said method comprising the steps of (i) detecting a touch or near-touch of an object on or near said touch input area, said object comprising one or more fingers bunched together: (ii) determining a parameter indicative of the size and/or shape of said object; (iii) comparing said parameter with at least one predetermined value and (iv) on the basis of said comparison, differentiating said object as a single finger or as a plurality of fingers bunched together.

16. A method according to claim 15, further comprising the step of (v) enabling a function of said touch input device in response to said the differentiation of said object.

17. A method according to claim 15, wherein said parameter is compared with one or more predetermined threshold values, said threshold values delimiting a plurality of functions such that the size and/or shape of said object enables one or more of said functions.

18. A method according to any one of claim 15, further comprising the step of (vi) monitoring motion of said object on or near said touch input area.

19. A method according to claim 18, further comprising the step of (vii) enabling a function of said touch input device in response to said motion and the number f fingers determined to comprise said object.

20. A method according to claim 19, wherein said touch input area is operatively associated with a display, and said function is associated with a graphical element displayed on said display.

21. A method according to claim 20, wherein said motion is a swipe on said touch input area and said function comprises movement of said graphical element if said object is determined to comprise one finger, or rotation of said graphical element if said object is determined to comprise two or more fingers bunched together.

22. A method for interacting with a touch input device comprising a touch input area, said method comprising placing one more touch objects on or near said touch input area, wherein at least one of said touch objects comprises at least two fingers bunched together.

23. A method according to claim 22, further including motion of said groups of fingers across said touch input area.

24. (canceled)

25. (canceled)

26. (canceled)

27. (canceled)

28. (canceled)

29. (canceled)

30. (canceled)

31. (canceled)

32. A method according to claim 1, wherein the number of said predetermined values is user-definable.

33. A method according to claim 1, wherein the magnitude of each predetermined value is user-definable.

34. A method according to claim 1, wherein said parameter is selected from the group consisting of: a linear dimension of said object; an area of said object; and a measure of symmetry of said object.

35. A method according to claim 1, wherein said predetermined value is a linear dimension threshold in the range of 2 mm to 5 mm, or an area threshold in the range of 4 mm² to 25 mm².

36. A method according to claim 5, wherein the number os faid predetermined values is user-definable.

37. A method according to claim 5, wherein the magnitude of each predetermined value is user-definable.

38. A method according to claim 5, wherein said parameter is selected from the group consisting of: a linear dimension of said object; an area of said object; and a measure of symmetry of said object.

39. A method according to claim 5, wherein said predetermined value is a linear dimension threshold in the range of 2 mm to 5 mm, or an area threshold in the range of 4 mm² to 25 mm².

40. A method according to claim 7, wherein the number of said predetermined values is user-definable.

41. A method according to claim 7, wherein the magnitude of each predetermined value is user-definable.

42. A method according to claim 7, wherein said parameter is selected from the group consisting of: a linear dimension of said object; an area of said object; and a measure of symmetry of said object.

43. A method according to claim 7, wherein said predetermined value is a linear dimension threshold in the range of 2 mm to 5 mm, or an area threshold in the range of 4 mm² to 25 mm².

44. A method according to claim 7, wherein said cursor is a graphical representation of a stylus or a hand holding a stylus if said touch object is classified as being a stylus.

45. A method according to claim 7, wherein said cursor is a graphical representation of a pointing hand, a finger or a group of fingers if said touch object is classified as being a finger or a group of fingers.

46. A method according to claim 11, wherein the number of said predetermined values is user-definable.

47. A method according to claim 11, wherein the number of said predetermined values is user-definable.

48. A method according to claim 11, wherein said parameter is selected from the group consisting of: a linear dimension of said object; an area of said object; and a measure of symmetry of said object.

49. A method according to claim 11, wherein said predetermined value is a linear dimension threshold in the range of 2 mm to 5 mm, or an area threshold in the range of 4 mm² to 25 mm².

50. A method according to claim 12, wherein said parameter is selected from the group consisting of: a linear dimension of said object; an area of said object; and a measure of symmetry of said object.

51. A method according to claim 15, wherein the number of said predetermined values is user-definable.

52. A method according to claim 15, wherein the magnitude of each predetermined value is user-definable.

53. A method according to claim 15, wherein said parameter is selected from the group consisting of: a linear dimension of said object; an area of said object; and a measure of symmetry of said object.

54. A method according to claim 15, wherein said predetermined value is a linear dimension threshold in the range of 2 mm to 5 mm, or an area threshold in the range of 4 mm² to 25 mm².
